(19) United States
(12) Patent Application Publication
(10) Pub. No.: US 2012/0187828 A1
(43) Pub. Date: Jul. 26, 2012

(54) PLASMA DISPLAY PANEL AND METHOD OF MANUFACTURING SAME

(76) Inventors: Young-Kwan Kim, Yongin-si (KR); Eun-Gi Heo, Yongin-si (KR); Kyung-Cheol Choi, Daejeon (KR); Seong-Min Lee, Daejeon (KR)

(21) Appl. No.: 13/237,021

(22) Filed: Sep. 20, 2011

(30) Foreign Application Priority Data
Jan. 26, 2011 (KR) 10-2011-0007907

(51) Int. Cl. H01J 17/49; H01J 9/22

(52) U.S. Cl. 313/584; 445/58

(57) ABSTRACT

A plasma display panel includes first and second substrates opposite to each other; a plurality of address electrodes disposed on one surface of the first substrate; a plurality of display electrodes disposed in a perpendicular direction to the address electrodes on one surface of the second substrate; and red, green, and blue phosphor layers disposed in a discharge space between the first and second substrates. At least one of the phosphor layers include a phosphor coated with a metal.

### CROSS-REFERENCE TO RELATED APPLICATION

This application claims priority to and the benefit of Korean Patent Application No. 10-2011-0007907, filed in the Korean Intellectual Property Office on Jan. 26, 2011, the entire content of which is incorporated herein by reference.

### BACKGROUND

1.Field

This disclosure relates to a plasma display panel (PDP) and a method of manufacturing the same.

2.Description of Related Art

A PDP is a display device that forms an image by exciting phosphor with vacuum ultraviolet (VUV) rays generated by gas discharge. Since a PDP is capable of forming a large, high-resolution screen, it is drawing attention as a next-generation thin display device.

In general, a PDP has address electrodes on a rear substrate extending in one direction and a dielectric layer covering the address electrode. On the dielectric layer, barrier ribs having a stripe pattern are disposed between each address electrode. Red (R), green (G), and blue (B) phosphor layers are disposed between each barrier rib.

A display electrode including a pair of transparent electrodes and a bus electrode is formed on one surface of a front substrate extending in a direction perpendicular to the address electrodes. A dielectric layer and an MgO protective layer cover the display electrode on the front substrate. Where the address electrodes on the rear substrate cross the display electrode on the front substrate, discharge cells are formed.

The PDP is operated by applying an address voltage (Va) between the address electrode and the display electrode to perform address discharge and applying a sustain voltage (Vs) between a pair of the display electrodes to perform sustain discharge. Herein, an excitation source is generated that excites each phosphor. The phosphors emit a visible light through a transparent front substrate, realizing images of the PDP. The excitation source may mainly include a VUV ray.

The phosphor layers are formed by using red, green, and blue phosphors. Each phosphor emits a visible light by way of a resonance ray (147 nm VUV ray) of Xe ions.

Research into phosphors for PDPs have focused on improving fluorescent materials used for phosphor-applying products, such as cathode ray tubes (CRT) and the like. However, phosphors useful for PDPs should have improved light emitting luminance.

### SUMMARY

One aspect of the present invention provides a plasma display panel (PDP) including a phosphor layer with improved luminance and reduced reflective luminance.

Another aspect of the present invention provides a method of manufacturing the PDP.

According to an aspect of the present invention, a PDP includes first and second substrates arranged opposite to each other; a plurality of address electrodes on a first surface of the first substrate facing the second substrate, each of the plurality of address electrodes extending in a first direction; a plurality of display electrodes on a surface of the second substrate facing the first substrate and extending in a direction perpendicular to the first direction; and red, green, and blue phosphor layers in a discharge space between the first and second substrates. At least one of the phosphor layers includes phosphor powder coated with a metal.

The metal may be selected from silver (Ag), aluminum (Al), gold (Au), platinum (Pt), palladium (Pd), copper (Cu), and combinations thereof.

The metal may be a metal particle or a metal thin film.

The metal particle may be selected from the group consisting of spherical, a polyhedral, and combinations thereof.

The metal particle may have a longer axis and a shorter axis and the longer axis may be from about 10 nm to about 120 nm.

The metal particle may directly contact the phosphor powder or the metal particle may maintain an average distance of less than or equal to about 20 nm or about 0.5 nm to about 10 nm.

The metal thin film may have a thickness of from about 10 nm to about 120 nm or from about 50 nm to about 70 nm.

The phosphor layer may include the metal at about 0.01 wt % to about 5 wt % based on the total weight of the phosphor powder and the metal.

According to another embodiment of the present invention, a method of manufacturing a PDP includes mixing a solution including a metal-containing salt with a phosphor powder; heat-treating the mixture to prepare phosphor powder coated with metal; preparing a composition for a phosphor layer by mixing the phosphor powder coated with metal, a binder, and a solvent; and coating the composition for a phosphor layer in a discharge space of the PDP and heat-treating it.

The metal-containing salt may be selected from metal nitrate (M(NO₃)ₓ, where M is a metal and x the oxidation state of M), metal chloride (MClₓ, where M is a metal and x is the oxidation state of M), metal fluoride (MFₓ, where M is a metal and x is the oxidation state of M), metal sulfate(M(SO₄)ₓ, where M is a metal and x is the oxidation state of M), and combinations thereof.

M may be silver (Ag), aluminum (Al), gold (Au), platinum (Pt), palladium (Pd) or copper (Cu), or combinations thereof.

According to another embodiment, a method of manufacturing a PDP includes mixing metal, phosphor powder, and an organic adhesive in a solvent; heat-treating the mixture to prepare phosphor powder coated with metal; preparing a composition for a phosphor layer by mixing the phosphor powder coated with metal with a binder and a solvent; coating the composition for a phosphor layer in a discharge space of the PDP and heat-treating the coating.

The organic adhesive may be selected from gelatin, polyvinylalcohol, and a cellulose-based compound.

### BRIEF DESCRIPTION OF THE DRAWINGS

These and/or other aspects will become apparent and more readily appreciated from the following description of the embodiments, taken in conjunction with the accompanying drawings in which:

FIG. 1 is a schematic view depicting a phosphor coated with spherical particle-shaped metal according to one embodiment;

FIG. 2 is a schematic view depicting a phosphor coated with hexahedron particle-shaped metals according to another embodiment;

FIG. 3 is a schematic view depicting a phosphor coated with a thin film-shaped metal according to another embodiment;

FIG. 4 is a schematic view depicting a phosphor with an internal space including a spherical particle-shaped metal according to another embodiment;

FIG. 5 is a schematic view depicting a phosphor with an inner space coated with a thin film-shaped metal according to another embodiment;

FIG. 6 is an exploded perspective view showing a PDP according to one embodiment; and

FIG. 7 is the photoluminescence spectra of the PDPs according to Examples 1 and 2 and Comparative Examples 1 and 2.

### DETAILED DESCRIPTION

The following detailed description references certain exemplary embodiments, examples of which are illustrated in the accompanying drawings. Throughout the description, like reference numerals refer to like elements. In this regard, the described embodiments are exemplary, and those of ordinary skill in the art will appreciate that certain modifications can be made to the described embodiments. This description is not limited to the particular embodiments described.

In the drawings, the thickness of layers, films, panels, regions, etc., may be exaggerated for clarity. It will be understood that when an element such as a layer, film, region, or substrate is referred to as being “on” another element, it can be directly on the other element or intervening elements may also be present. In contrast, when an element is referred to as being “directly on” another element, there are no intervening elements present.

According to one embodiment of the present invention, a plasma display panel (PDP) may include first and second substrates arranged opposite to each other. A plurality of address electrodes may be on one surface of the first substrate. A plurality of display electrodes may be on one surface of the second substrate and may be in a perpendicular direction to the address electrodes. That is, each of the address electrodes may extend in a first direction and each of the display electrodes may extend in a direction perpendicular to the first direction. Red, green, and blue phosphor layers may be in a discharge space between the first and second substrates. Each of the phosphor layers may include phosphor powder coated with a metal.

The phosphor layer has surface plasmon resonance effects as a result of an external light source and the coated metal. The surface plasmon resonance effect occurs between the metal and the phosphor powder when light energy from the external light source vibrates inside the metal and is amplified. Accordingly, PDPs using phosphor powders described herein as a light source may be improved. In the specification, “coating” includes surfaces in direct contact and surfaces spaced apart by about 20 nm or less.

When a phosphor layer is formed by simply mixing phosphor powder and a metal, the phosphor powder and the metal may be far away, i.e., at a distance of about 100 nm to about 500 nm. Accordingly, most of the metal does not participate the surface plasmon resonance effect.

However, the phosphor powder coated with the metal according to embodiments of the present disclosure include phosphors that are relatively close to the metal, and thus, may result in surface plasmon resonance effects, improving luminance.

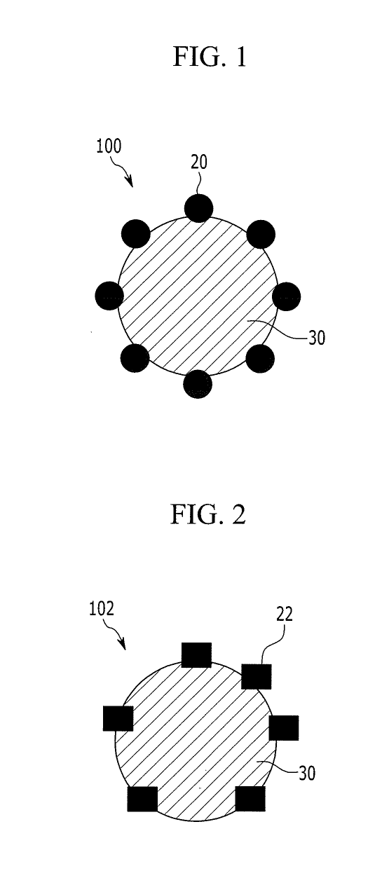

FIGS. 1 to 5 provide a schematic diagram showing phosphor powder coated with a metal according to various embodiments of the present invention.

The metal may be coated as nano-sized metal particles or as a metal layer having a nano-thickness. The nano-sized particles and nano-thickness range from several nanometers to hundreds of nanometers. For instance, the nano-sized particles and nano-thickness may be from about 10 nm to about 200 nm. The nano-sized metal particle may have various shapes selected from spherical, polyhedral, and combinations thereof. A polyhedral shape could be tetrahedral, hexahedral, star-shaped, and the like, however, any suitable polyhedron may be used.

FIG. 1 provides a schematic diagram showing a coated phosphor 100 including a phosphor 30 coated with spherical metal particles 20. FIG. 2 is a schematic diagram showing a coated phosphor 102 including a phosphor 30 with coated with hexahedral metal particles 22.

The metals 20 and 22 may be selected from silver (Ag), aluminum (Al), gold (Au), platinum (Pt), palladium (Pd), copper (Cu), and combinations thereof. However, any suitable metal 20 and 22 may be used.

The nano-sized metal particles have a longer axis and a shorter axis and the longer axis may be about 10 nm to about 120 nm. When the particles are defined as “spherical,” it is intended that the particles are generally spherical such that the shorter axis and longer axis are generally the same, and represent the diameter of the generally spherical particles. In some embodiments, the nano-sized metal particles may have a longer axis of about 50 nm to about 90 nm. When metal particles have a longer axis within the above range, they luminance of a PDP may be improved.

The metals 20 and 22 may directly contact phosphor powder 30 or may be separated from the phosphor powder 30 by a distance of less than or equal to 20 nm or from about 0.5nm to about 10 nm (the metals and phosphor powders may be separated, e.g., as a result of the use of an adhesive). In some embodiments, when metal particles are closer to or in direct contact with the phosphor powder, they may result in improved surface plasmon resonance effects, thereby improving luminance.

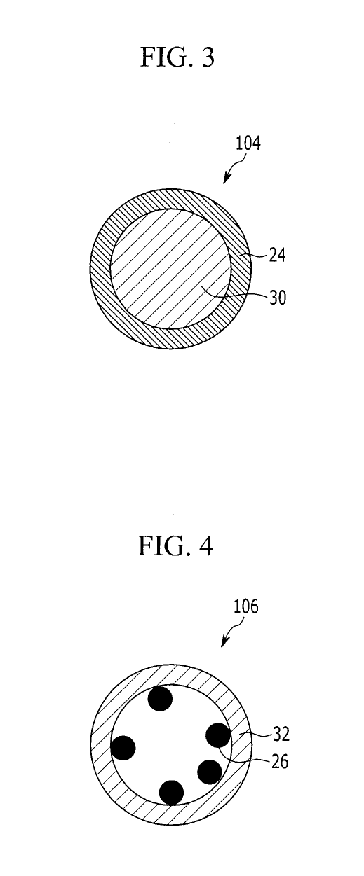

FIG. 3 is a schematic diagram showing the cross-section of a coated phosphor 104 including phosphor powder 30 coated with thin film-shaped metal 24. As shown in FIG. 3, the surface of the phosphor powder 30 is surrounded by a thin film metal 24.

The thin film-shaped metal 24 may have a thickness ranging from about 10 nm to about 120 nm. In some embodiments, the thin film-shaped metal 24 may have a thickness of about 50 nm to about 90 nm. When the thin film-shaped metal 24 has a thickness within the range, luminance may be improved.

The phosphor layer may include the metal at about 0.01 wt % to about 5 wt % based on the total weight of phosphor powder and the metal. In some embodiments, the phosphor layer may include the metal at about 0.1 wt % to about 2 wt % based on the total weight of phosphor powder and the metal., When the metal is included within this range, surface plasmon resonance effect may be improved, thus improving luminance.

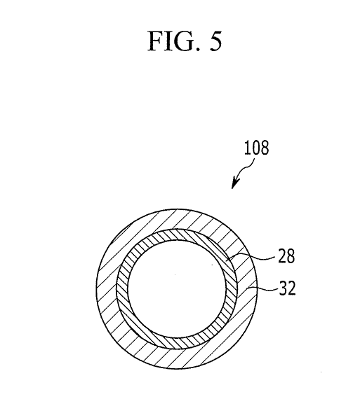

The phosphor may be a powder and additionally, may be hollow. The hollow phosphor powder may have a metal coating inside. Thus, reducing the possibility that the metal may be damaged. FIG. 4 is a schematic diagram showing the cross-section of a coated phosphor 106 including phosphor powder 32 coated with spherical particle metal particles 26 in the inner space of the hollow phosphor powder 32 according to another embodiment of the present invention. FIG. 5 is a schematic diagram showing the cross-section of a coated phosphor 108 including phosphor powder 32 coated with a metal thin film 28 in the inner space of the hollow phosphor powder 32 according to another embodiment of the present invention.

According to still another embodiment of the present invention, a method of manufacturing a PDP includes mixing a solution including a metal-containing salt with phosphor powder; heat-treating the mixture to prepare phosphor powder coated with metal powder; preparing a composition for a phosphor layer by mixing the phosphor powder coated with the metal powder, a binder, and a solvent; and coating the composition for a phosphor layer in a discharge space of the PDP (e.g., coating the composition on the first dielectric layer in the discharge space between the substrates) and heat-treating the coating (e.g., by heat treating the PDP).

The metal-containing salt may be selected from a metal nitrate (M(NO₃)ₓ, where M is a metal and x the oxidation state of M), metal chloride (MClₓ, where M is a metal and x is the oxidation state of M), metal fluoride (MF_{X}, where M is a metal and x is the oxidation state of M), metal sulfate(M(SO₄)ₓ, where M is a metal and x is the oxidation state of M), and combinations thereof. However, any suitable metal-containing salt may be used. The metal (M) may be silver (Ag), aluminum (Al), gold (Au), platinum (Pt), palladium (Pd) or copper (Cu), or combinations thereof. In some embodiments, the metal-containing salt may include AgNO₃.

The metal-containing salt coated on the phosphor powder may be reduced into a metal as a result of heat treatment or a reducing agent. The reducing agent may be, for example, NaBH₄, NaOH, hydrazine (N₂H₄), ethylene glycol, and the like.

According to another embodiment of the present invention, a method of manufacturing a PDP may include mixing metal powder, phosphor powder, and an organic adhesive in a solvent; heat-treating the mixture to prepare phosphor powder coated with metal powder; preparing a composition for a phosphor layer by mixing the phosphor powder coated with metal powder, a binder, and a solvent; and coating and heat-treating the composition for a phosphor layer in the discharge space of a PDP.

The organic adhesive (i.e. adherent organic material) may be, for example, gelatin, polyvinylalcohol, a cellulose-based compound, and the like, however, any suitable organic adhesive may be used. The cellulose-based compound may be, for example, carboxyl methyl cellulose, methyl cellulose, ethyl cellulose, hydroxypropyl methylcellulose, hydroxypropyl ethylcellulose, or salts thereof. The salt of the cellulose-based compound may be, for example, salt of an alkali metal such as Na, K, or Li.

The organic adhesive may be used in an amount ranging from about 0.1 to about 3 parts by weight based on 100 parts by weight of the metal powder. When the organic adhesive is used within this range, it may closely adhere the metal powder to phosphor powder without substantially damaging the characteristics of phosphor powder. Additionally, when the organic adhesive is used within this range, the surface plasmon resonance effect may be present.

The heat treatment (i.e., the heat treatment of the mixture of metal powder, phosphor powder, and organic adhesive in a solvent) may be performed at a temperature ranging from about 50° C. to about 200° C. Through the heat treatment process, the organic adhesive may exist between the metal powder and the phosphor powder or the organic adhesive may be removed.

The heat-treating the coating (i.e., the heat-treatment of the PDP) or the heat-treating the composition may be performed at a temperature ranging from about 50° C. to about 200° C. Alternatively, the heat-treating the coating or the heat-treating the composition may be performed at a temperature ranging from about 50° C. to about 500° C.

In addition, as shown in FIG. 3, the coated phosphor 104 including phosphor powder 30 coated with a metal thin film 24 may be prepared via a deposition method. The deposition method may be selected from any suitable method including sputtering, PVD (physical vapor deposition), chemical vapor deposition (CVD), plasma enhanced chemical vapor deposition (PECVD), thermal chemical vapor deposition, ion beam evaporation, vacuum thermal evaporation, laser ablation, thermal evaporation, and e-beam evaporation.

The coated phosphor 106 as shown in FIG. 4 may be prepared, for example, by mixing a solution including a metal-containing salt and hollow phosphor powder 32 so that the metal-containing salt moves inside the hollow phosphor powder 32. The metal-containing salt may then be reduced into a metal, forming spherical metal particles 26 on the inner surface of the hollow phosphor powder 32.

In addition, the coated phosphor 108 as shown in FIG. 5 may be prepared to include hollow phosphor powder 32 coated with a metal thin film 28 on an inner surface of the hollow phosphor powder 32. The inner coating may be formed, for example, by adjusting a pH of the solution including the metal-containing salt, a temperature during reduction of the salt, a speed of providing the metal-containing salt, and the like, thereby controlling conditions for eluting a metal.

The phosphor is mixed with a binder and a solvent to prepare a composition for a phosphor layer. The binder may be, for example, a cellulose-based resin such as ethylcellulose, an acryl resin, and the like, however, any suitable binder may be used. The solvent may be, for example, an organic solvent such as hexanetriol, polypropylene glycol, diethylene glycol n-butyl ether acetate (e.g., butyl carbitolacetate), terpineol, and the like, however, any suitable solvent may be used.

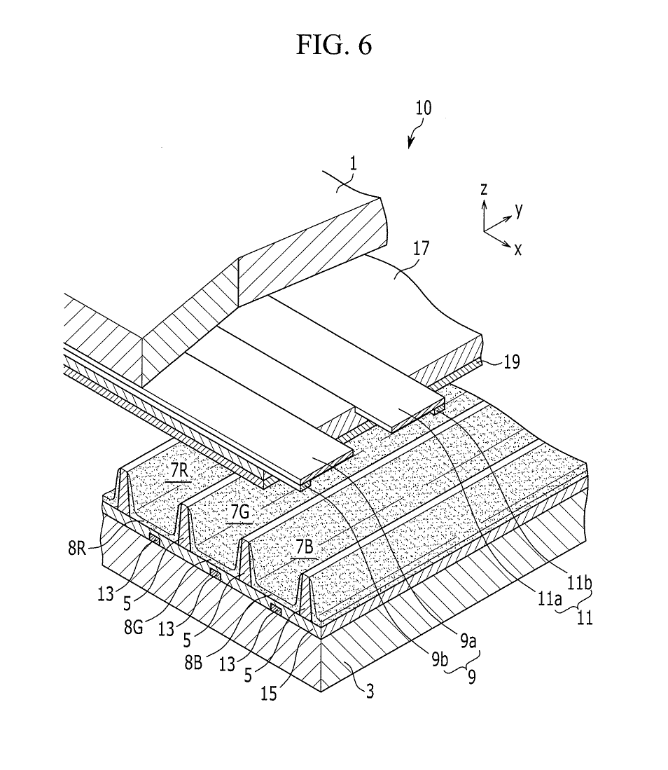

FIG. 6 is a partial exploded perspective view of a plasma display panel 10 according to the another embodiment of the present invention. Referring to FIG. 6, the plasma display panel 10 includes a plurality of address electrodes 13 extending in one direction (the Y direction in the drawing) on a first substrate 3, and a first dielectric layer 15 is covering the address electrodes 13. Barrier ribs 5 are formed on the first dielectric layer 15, and red (R), green (G), and blue (B) phosphor layers 8R, 8G, and 8B are in discharge cells 7R, 7G, and 7B formed between the barrier ribs 5.

The barrier ribs 5 may be any shape as long as their shape partitions the discharge cells. Therefore, suitable barrier ribs 5 may have different patterns. For example, the barrier ribs 5 may be formed as an open type, such as a stripe, or as a closed type, such as a waffle, matrix, or delta shape. Closed type barrier ribs may be formed such that a horizontal cross-section of the discharge space is a polygon (such as a quadrangle, a triangle, and a pentagon), a circle, or an oval.

Pairs of display electrodes 9 and 11, each pair including pairs of transparent electrodes 9a and 11a and bus electrodes 9b and 11b, extend in a direction perpendicular to the direction the address electrodes 13 extend along (i.e., the display electrodes extend in an X direction in the drawing) on one surface of a second substrate 1 facing the first substrate 3. Also, a second dielectric layer 17 and a protective layer 19 are on the second substrate 1 and cover the display electrodes.

Discharge cells are formed at positions where the address electrodes 13 of the first substrate 3 cross the display electrodes 9 and 11 of the second substrate 1.

In the plasma display panel 10, address discharge is performed by applying an address voltage (Va) to a space between the address electrodes 13 and the display electrodes 9 and 11. When a sustain voltage (Vs) is applied to a space between a pair of display electrodes 9 and 11, an excitation source generated from the sustain discharge excites a corresponding phosphor layer to thereby emit visible light through the second substrate 1 and thereby display an image. The phosphors are usually excited by vacuum ultraviolet (VUV) rays.

The red R, green G, and blue B phosphor layers 8R, 8G, and 8B include a phosphor coated with a metal. These phosphor layers improve luminance of a PDP and additionally reduce reflective luminance.

The following examples illustrate the present invention in more detail. These examples, however, should not be interpreted as limiting the scope of the present invention.

### Fabrication of a PDP

### EXAMPLE 1

A phosphor with a structure shown in FIG. 1 was prepared by mixing 1 g of Ag spherical shape powder having a 70 nm diameter, 100 g of BaMgAl₁₀O₁₇:Eu blue phosphor powder, and 0.1 g of gelatin. The mixture was then heat-treated at a temperature ranging from 25° C. to 50° C. to coat the Ag powder on the surface of the BaMgAl₁₀O₁₇:Eu blue phosphor powder.

Then, a mixed solvent was prepared by mixing butyl Carbitol acetate and terpineol in a weight ratio of 3:7. Based on 100parts by weight of the mixed solvent, 6 parts by weight of ethyl cellulose as a binder and 40 parts by weight of the BaMgAl₁₀O₁₇:Eu blue phosphor powder coated with Ag were added thereto to prepare a blue phosphor paste.

The blue phosphor paste was coated inside the discharge cell of a first substrate with barrier ribs. The first substrate coated with the blue phosphor paste was dried and fired to prepare a phosphor layer including the blue phosphor coated with Ag. Ag was included at 1 wt % based on the weight of the phosphor powder and a metal.

In addition, red((Y,Gd)BO₃:Eu, Y(P,V)O₄:Eu) and green (YAl₃(BO)₄:Tb) phosphor layers were formed in each red and green discharge cell according to the same method as aforementioned, however, they were not mixed with metal particles.

The first substrate having the red, green, and blue phosphor layers and a second substrate having a display electrode were assembled, sealed, exhausted, implanted, and aged, fabricating a PDP.

### EXAMPLE 2

A PDP was fabricated according to the same method as Example 1 except that Ag was deposited on BaMgAl₁₀O₁₇:Eu blue phosphor powder by an ion adsorption to form a 70 nm-thick coating layer.

### COMPARATIVE EXAMPLE 1

A PDP was fabricated according to the same method as Example 1 except that Ag particles having a 70 nm diameter were merely mixed with BaMgAl₁₀O₁₇:Eu blue phosphor powders to prepare the phosphor (i.e., no heat treatment to coat the metal on the phosphor was used).

### COMPARATIVE EXAMPLE 2

A PDP was fabricated according to the same method as Example 1 except for using BaMgAl₁₀O₁₇:Eu blue phosphor powders (i.e., no metal was used).

### Luminance Measurement of a Blue Phosphor Layer

Each blue phosphor layer of the PDPs according to Examples 1 and 2 and Comparative Examples 1 and 2 were measured for luminance by using a Xenon lamp with a 147 nm and 171 nm wavelength as a light source to obtain a radiating photoluminescence (PL) spectrum.

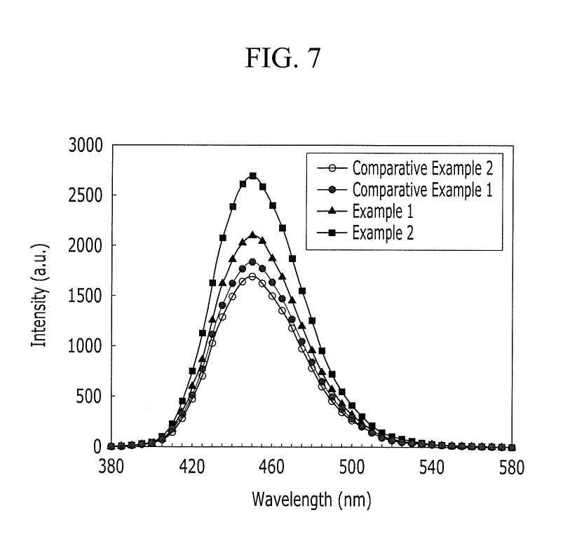

FIG. 7 shows the PL spectra of the blue phosphor layers of the plasma display panels (PDP) according to Examples 1 and 2 and Comparative Examples 1 and 2. The luminance ratios of Examples 1 and 2 and Comparative Example 2 relative to Comparative Example 1 at the main wavelength of 450 nm were measured. The results are provided in the following Table 1.

TABLE 1

| | | | Compara- | Compara- |
|---|---|---|---|---|
| | Exam- | Exam- | tive | tive |
| Main wavelength of 450 nm | ple 1 | ple 2 | Example 1 | Example 2 |
| PL luminance ratio (%) | 114.5 | 145.5 | 100.0 | 93.4 |
| relative to Comparative | | | | |
| Example 1 | | | | |

As shown in Table 1, each blue phosphor layer of the PDPs, including phosphor powder coated with Ag according to Examples 1 and 2, had excellent PL luminance compared with a blue phosphor layer prepared by simply mixing Ag with a blue phosphor as shown in Comparative Example 1. In particular, phosphor powders coated with an Ag thin film according to Example 2 had excellent luminance improvement compared with phosphor powders coated with Ag particles according to Example 1, because the phosphor powders had a minimum distance from the Ag.

While this disclosure has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims and their equivalents.

What is claimed is:

1. A plasma display panel comprising:
first and second substrates arranged opposite to each other;
a plurality of address electrodes on a surface of the first substrate facing the second substrate, each of the plurality of address electrodes extending in a first direction;
a plurality of display electrodes on a surface of the second substrate facing the second substrate and extending in a direction perpendicular to the first direction; and
red, green, and blue phosphor layers in a discharge space between the first and second substrates, at least one of the red, green, and blue phosphor layers comprising phosphor powder coated with a metal.

2. The plasma display panel of claim 1, wherein the metal is selected from the group consisting of Ag, Al, Au, Pt, Pd, Cu, and combinations thereof.

3. The plasma display panel of claim 1, wherein the metal is a metal particle or a metal thin film.

4. The plasma display panel of claim 3, wherein the metal is the metal particle and the metal particle has a shape selected from the group consisting of spherical, polyhedral, and combinations thereof.

5. The plasma display panel of claim 3, wherein the metal is the metal particle, and the metal particle has a longer axis and a shorter axis, and the longer axis is about 10 nm to about 120 nm.

6. The plasma display panel of claim 5, wherein the longer axis of the metal particle is about 50 nm to about 90 nm.

7. The plasma display panel of claim 3, wherein the metal is a spherical metal particle having a diameter of about 10 nm to about 120 nm.

8. The plasma display panel of claim 3, wherein the metal is the metal particle and the metal particle directly contacts the phosphor powder or the metal particle is spaced apart from the phosphor powder by an average distance of less than or equal to about 20 nm.

9. The plasma display panel of claim 3, wherein the metal is the metal thin film, and the thickness of the metal thin film is about 10 nm to about 120 nm.

10. The plasma display panel of claim 9, wherein the thickness of the metal thin film is from about 50 nm to about 70 nm.

11. The plasma display panel of claim 1, wherein the metal is present at about 0.01 wt % to about 5 wt % based on the total weight of phosphor powder and the metal.

12. The plasma display panel of claim 11, wherein the metal is present at about 0.1 wt % to about 2 wt % based on the total weight of phosphor powder and the metal.

13. The plasma display panel of claim 1, wherein the metal is present inside the phosphor powder.

14. A method of manufacturing a plasma display panel comprising:
mixing a solution comprising a metal-containing salt and a phosphor powder to prepare a mixture;
heat-treating the mixture to prepare a phosphor powder coated with a metal;
preparing a composition by mixing the phosphor powder coated with metal, a binder, and a solvent; and
coating the composition in a discharge space of the plasma display panel and heat-treating the coating.

15. The method of claim 14, wherein the metal-containing salt is selected from the group consisting of:
M(NO₃)ₓ where M is a metal and x is the oxidation state of M,
MClₓ where M is a metal and x is the oxidation state of M,
MFₓ where M is a metal and x is the oxidation state of M,
M(SO₄)ₓ where M is a metal and x is the oxidation state of M, and combinations thereof.

16. The method of claim 15, wherein the M is Ag, Al, Au, Pt, Pd, Cu, or combinations thereof.

17. A method of manufacturing a plasma display panel comprising:
mixing metal, phosphor powder, and an organic adhesive in a solvent to prepare a mixture;
heat-treating the mixture to prepare phosphor powder coated with metal;
preparing a composition for a phosphor layer by mixing the phosphor powder coated with metal, a binder, and a solvent; and
coating the composition in a discharge space of the plasma display panel and heat-treating the coating.

18. The method of claim 17, wherein the organic adhesive comprises a material selected from the group consisting of gelatin, polyvinylalcohol, a cellulose-based compound, and combinations thereof.
